(19) United States
(12) Patent Application Publication
(10) Pub. No.: US 2020/0262109 A1
(43) Pub. Date: Aug. 20, 2020

(54) MODULAR MOLD SYSTEM FOR CONTAINERS

(71) Applicant: Becklin Holdings, Inc., Grants Pass, OR (US)

(72) Inventors: Jacob William Miller, Medford, OR (US); David J. Marks, Grants Pass, OR (US)

(21) Appl. No.: 16/277,978

(22) Filed: Feb. 15, 2019

(51) Int. Cl. B29C 33/30; B29C 70/44

(52) U.S. Cl. CPC B29C 33/302; B29K 2307/04; B29C 70/443

(57) ABSTRACT

A plurality of mold sections include end caps and a plurality of inner members, some of which define features, such as projections. Inner members are fastened between the end caps and define an open channel such that the end caps and interposed inner members define a volume and opening for molding a container, i.e., a female mold. Material is placed on inner surfaces of the inner members and end caps to form a container portion, such as a base or lid. The end caps and inner members may be disassembled and reassembled with a different number of inner members and used to form a container of a different size.

### FIELD OF THE INVENTION

This application relates to containers and, more particularly, to approaches for manufacturing containers.

### SUMMARY OF THE INVENTION

In the field of containers, particularly containers used for military applications or for transporting sensitive equipment, containers tend to be custom sizes corresponding to the size of the payload to be stored. This requirement increases the expense required to manufacture containers since custom tooling is required for each type of container. Most manufactures do not find it economically feasible to offer a wide range of container sizes.

What is needed is an improved approach for manufacturing containers of various sizes.

### BRIEF DESCRIPTION OF THE DRAWINGS

Preferred and alternative examples of the present invention are described in detail below with reference to the following drawings:

FIG. 1 is an isometric view of a mold for making a container formed of modular mold components in accordance with an embodiment of the present invention;

FIG. 2 is an isometric view of an end cap included in modular mold components in accordance with an embodiment of the present invention;

FIG. 3 is another isometric view of the end cap included in modular mold components in accordance with an embodiment of the present invention;

FIG. 4 is an isometric view of an inner mold component including an integrated feature in accordance with an embodiment of the present invention;

FIG. 5A is an isometric view of another example of an inner mold component in accordance with an embodiment of the present invention;

FIG. 5B is an isometric view of an inner mold component made of multiple sections in accordance with an embodiment of the present invention;

FIG. 6 is an isometric view of another mold formed of modular mold components in accordance with an embodiment of the present invention;

FIG. 7 is an isometric view of another mold formed of modular mold components in accordance with an embodiment of the present invention;

FIGS. 8 to 11 illustrate a process of manufacturing a container using a mold made of modular components in accordance with an embodiment of the present invention; and

FIG. 12 is a process flow diagram of a method for manufacturing a container using a mold made of modular components in accordance with an embodiment of the present invention.

### DETAILED DESCRIPTION OF THE PREFERRED EMBODIMENT

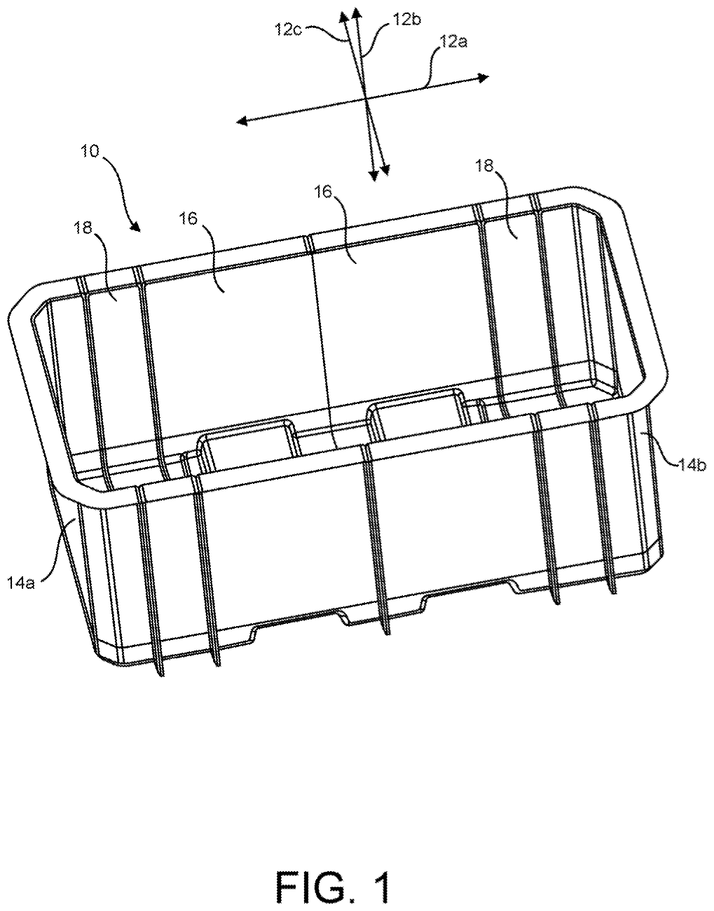

Referring to FIG. 1 a mold 10 may be formed out of modular components according to the embodiments disclosed herein. The disclosed embodiments may be understood with respect to a horizontal direction 12a, vertical direction 12b, and longitudinal direction 12c that are all mutually perpendicular to each other and do not necessarily correspond to actual horizontal, vertical, and longitudinal directions during use.

In the illustrated embodiment, a mold 10 is formed of mold caps 14a, 14b and one or more inner members 16, 18 or possibly no inner members in some applications. In the illustrated mold 10, some of the inner members 16 include features to be transferred to material placed in the mold. Others, such as inner members 18 lack features, other than surfaces for forming planar walls of the container with smoothing features such as chamfers or bevels at corners. As is apparent in FIG. 1, the inner members 16, 18 are U-shaped and define an open channel that, when joined with one another and the end caps 14a, 14b define an inner volume for molding a container. Note that a U-shaped inner member 16, 18 may itself be formed of multiple sections that are fastened together. For example, U-shaped inner members 16, 18 may be split along one or more planes that are parallel to the horizontal and vertical directions 12a, 12b, such as at the center of the U-shaped inner members. These sections may secure to one another using flanges as described below and the joint between them may be sealed to form a U-shaped member as described herein. In some embodiments, additional pieces may be positioned between these sections in order to achieve a custom length in the longitudinal direction 12c.

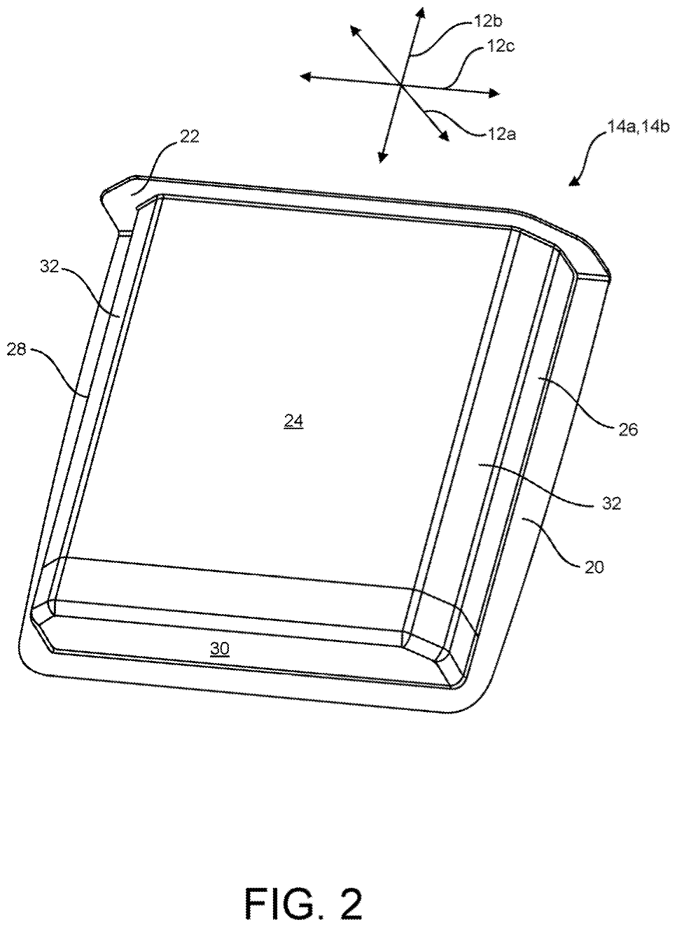

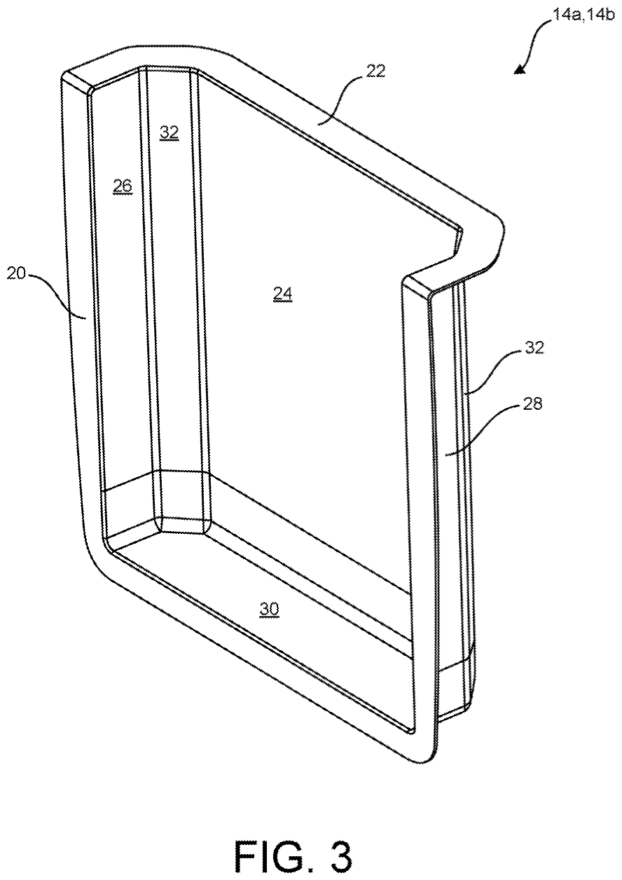

Referring to FIGS. 2 and 3, the end caps 14a, 14b may be identical or may be mirror images of one another. In other embodiments, the end caps 14a, 14b are different from one another. In the illustrated embodiment, the end cap 14a, 14b defines a flange 20 in a plane of the vertical and longitudinal directions 12a, 12b in use and may be used to secure to the flange 20 of another cap 14a, 14b or to a corresponding flange on an inner member 16, 18.

The end cap 14a, 14b may include a top flange extending around a top edge of the end cap 14a, 14b and extending outwardly from the top edge. The top flange may be planar parallel to the plane of the horizontal and longitudinal directions 12a, 12c.

In the illustrated embodiment, the end cap 14a, 14b defines part of the interior volume of the mold 10. In other embodiments, the end cap 14a, 14b may simply be planar and not of itself define a volume. In the illustrated embodiments, the end cap 14a, 14b defines 4 sides of a volume by including a side wall 24, front wall 26 and a rear wall 28 (front and rear are defined for the left end cap 14a but these labels would be reversed for the right end cap in FIG. 1). The side wall 24, front wall 26, and rear wall 28 may secure to a bottom wall 30.

In the illustrated embodiment, each wall 24, 26, 28, 30 includes a planar portion defining a major portion, and possibly the entirety of that wall 24, 26, 28, 30. In the illustrated embodiment, front and rear walls 26, 28 are substantially parallel (substantially parallel being defined as within 5 degrees of parallel in at least one plane intersection those entities that are described as substantially parallel). The walls 26, 28 and sidewall 24 may be substantially perpendicular (substantially perpendicular being defined as within 5 degrees of perpendicular) to the bottom wall 30. The sidewall 24 may be substantially perpendicular to the bottom wall 30 such that the walls 24, 26, 28, and 30 define a cuboid shape. Transitions between walls connected to one another may be smoothed by rounded corners, bevels, or chamfers. Note in particular the large chamfers 32 at the transition between the side wall 24 and the front and rear walls 26, 28 in the illustrated embodiment.

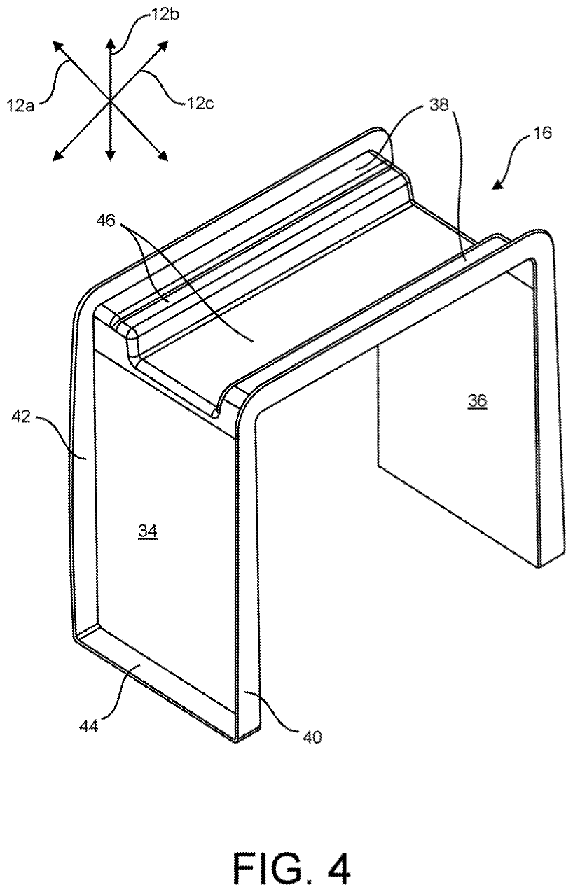

FIG. 4 illustrates an example of an inner member 16 that includes a front wall 34 and rear wall 36 that are substantially parallel to one another and a bottom wall 38 secured at bottom edges of the walls 34, 36 and that is substantially perpendicular to the walls 34, 36. In this manner, the walls 34, 36, 38 define an open channel. The inner surfaces of the walls 34, 36, 38 may lie on a cuboid shape that is identical in dimension along the vertical and longitudinal directions 12b, 12c to the cuboid defined by inner surfaces of the walls 26, 28, 30 of the end caps 14a, 14b. Similar to the end caps 14a, 14b, transitions between the walls 34 and 38 and between the walls 38 and 36 of the inner member 16 may include a rounded, chamfered or beveled transition and this transition may match the transition between the walls 26 and 30 and the walls 30 and 28 of the end caps 14a, 14b.

The illustrated inner member 16 defines one or more features 46 that protrude inwardly into the cuboid shape defined by the inner surfaces of the walls 34, 36, 38. In the illustrated embodiment, the feature 46 is an inward projection 46 that extends entirely across the bottom wall 38 along the longitudinal direction 12c and partially across the bottom wall 38 in the horizontal direction 12a. The inner surface of the projection 46 may be sized to create a cavity in a container that may be sized to receive a tine of a forklift or other lifting equipment.

Other features 46 that may be incorporated into an inner mold section 16 may include features for forming pockets or recesses of various sizes (e.g., projections that are the inverse of pockets formed thereby in a completed container), ribs (grooves or ridges that form ribs in a completed container), or other features.

Similar to the end cap 14a, 14b, the inner mold section 16 may include a left flange 40 extending along a left edge of the walls 34, 38, 36 and a right flange 42 extending along a right edge of the walls 34, 38, 36. In the illustrated embodiment, the left flange 40 includes a left facing planar face that is substantially parallel to a plane defined by the vertical and longitudinal directions 12b, 12c. Likewise, the right flange 42 includes a right facing planar face that is substantially parallel to a plane defined by the vertical and longitudinal directions 12b, 12c.

In the illustrated embodiment, the inner mold section 16 further includes a top flange 44 extending along a top edge of the front wall 34 and extending outwardly therefrom. The inner mold section 16 may further include a top flange 44 extending along a top edge of the rear wall 36 and extending outwardly therefrom.

In some embodiments, a feature may be formed on other surfaces other than the inner surface of the bottom wall 38 or the wall 30, such as some or all of the walls 24, 26, 28, 34, and 36. There may be various inner mold sections 16 having same or different features 46 and having same or different widths in the longitudinal direction 12a.

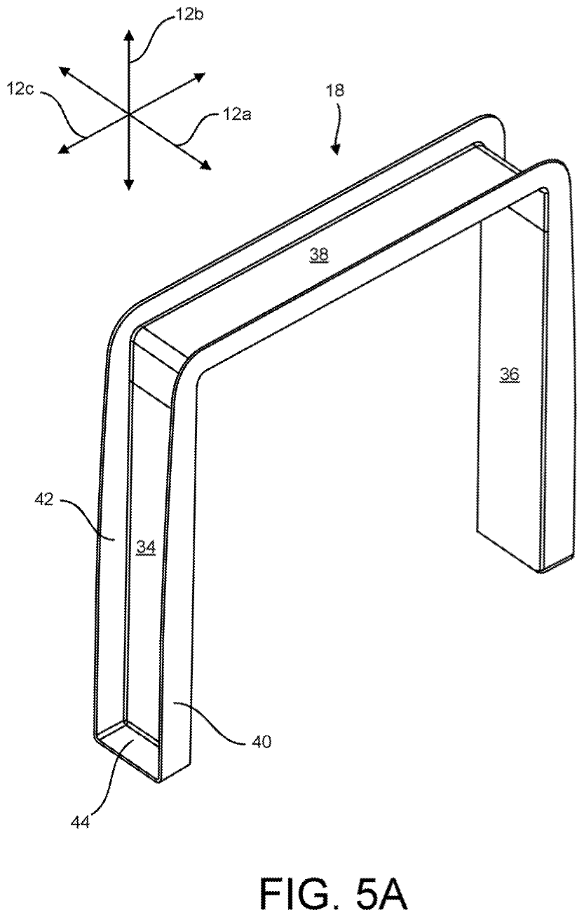

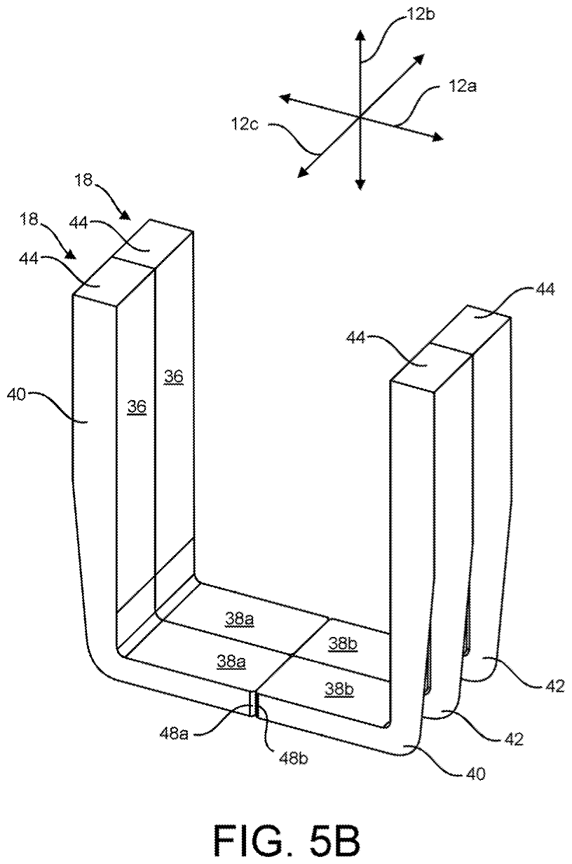

Referring to FIG. 5A, in some implementations, an inner mold section 18 may have the features of the inner mold section 16 but lack a feature 46. The inner mold section 18 may have a width in the longitudinal direction 12a that is the same as or different from the inner mold section 16. Likewise, there may be multiple inner mold sections 18 in a mold 10 that may have same or different widths in the longitudinal direction 12a.

Referring to FIG. 5B, an inner mold section 18 may be made of multiple sections. For example, the bottom wall 38 may be split into bottom wall sections 38a, 38b such that bottom wall section 38a is secured to rear wall 36 and bottom wall section 38b is secured to the front wall 34. The inner edges of the bottom wall sections 38a, 38b may include flanges 48a, 48b that may be secured to one another by means of bolts, clamps, adhesive, or other securement means. In some embodiments, one or more other sections may be secured between the bottom wall sections 38a, 38b and thereby form part of the bottom wall in order to alter the dimension of the inner mold section 18 in the horizontal direction 12a. The other sections may have upper surfaces that are substantially flush (within 3 mm, preferably within 1 mm, of flush) with the bottom wall sections 38a, 38b. Any other sections may likewise have flanges for securing to the flanges 48a, 48b by means of bolts, clamps, adhesive, or other fastening means.

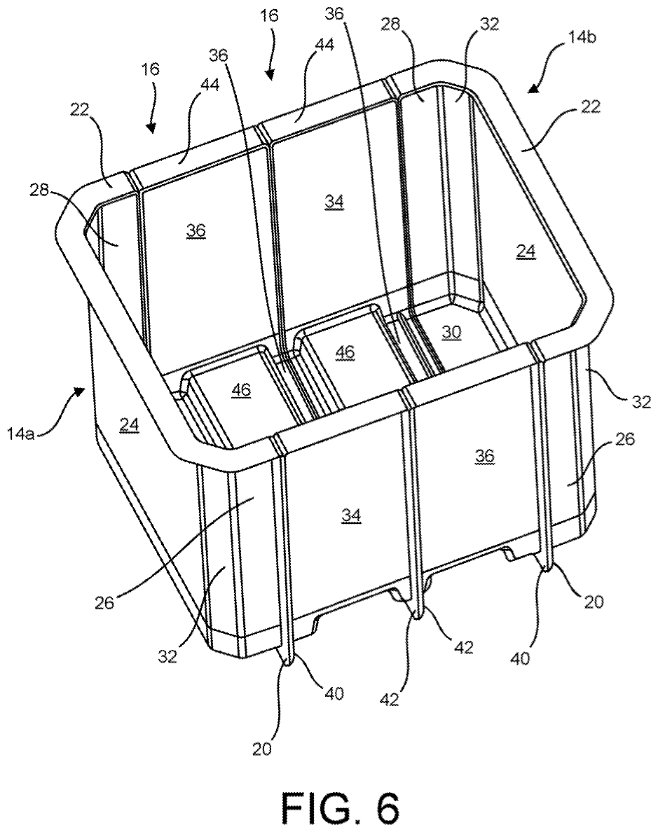

FIG. 6 illustrates one example of a mold 10 formed using end caps 14a, 14b and inner mold sections 16. As is apparent, the flange 20 of the end cap 14a is secured to the left flange 40 of one of the inner mold sections 16. The inner mold sections 16 that are adjacent to one another are fastened to one another such that the one on the left has its right flange 42 secured to the right flange 42 of the one on the right. The inner mold section on the right is mirrored relative to the one on the right in the illustrated configuration. A non-mirrored configuration is also possible. The end cap 14b on the right has its flange 20 secured to the left flange 40 of the inner mold section 16 adjacent to it. Securing one flange to another may be performed using a removable securing means such as nuts and bolts passing through openings in the flanges to be secured together, clips, an encircling band holding the mold sections 14a, 14b, 16 together or any other releasable securing means.

As is apparent in FIG. 6, the inner surfaces of the bottom walls 30, 38 of the mold sections 14a, 14b, 16 are substantially aligned with one another (substantially aligned being defined as there being a plane such that all are within 3 millimeters, preferably within 1 millimeters, of that plane). Likewise, front walls 26, 34 of the end caps 14a, 14b and inner mold sections 16 may be substantially aligned with one another and rear walls 28, 36 of the end caps 14a, 14b and the mold sections 16 may be substantially aligned with one another. The top flanges 22, 44 of the end caps 14a, 14b and inner mold sections 16 may likewise be substantially aligned.

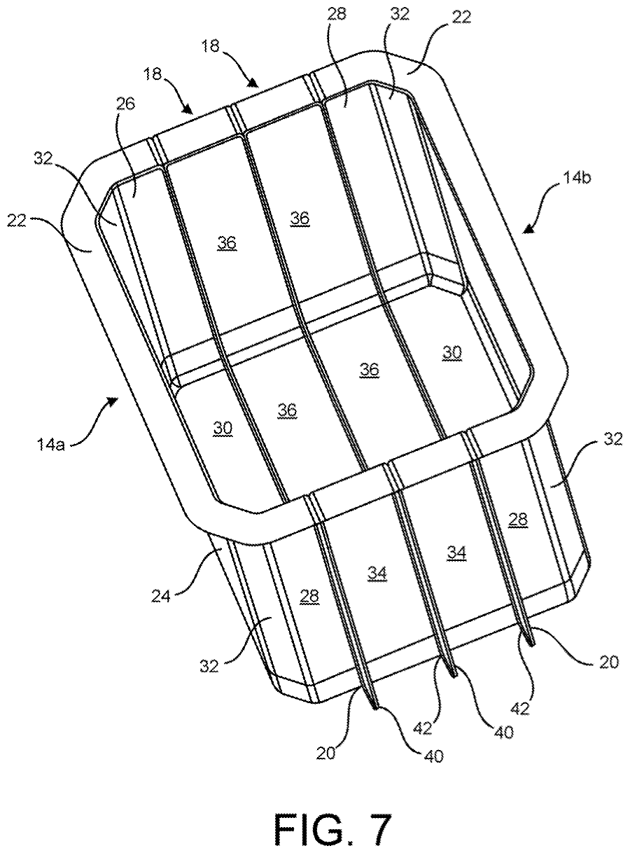

FIG. 7 illustrates another alternative mold that includes only inner mold sections 18 lacking features 46. The inner mold sections 18 and end caps 14a, 14b may be substantially aligned in the same manner as described with respect to FIG. 6.

The configurations of FIGS. 1, 6, and 7 are exemplary only. Any number of inner mold sections 16, 18 may be combined to achieve a desired configuration. Likewise, inner mold sections used to form a mold may be disassembled and some or all of the them reassembled, possibly with other inner mold sections 16, 18, in order to obtain a different mold with a different dimension in the longitudinal direction 12a and possibly with a different arrangement of mold sections 16 and mold sections 18.

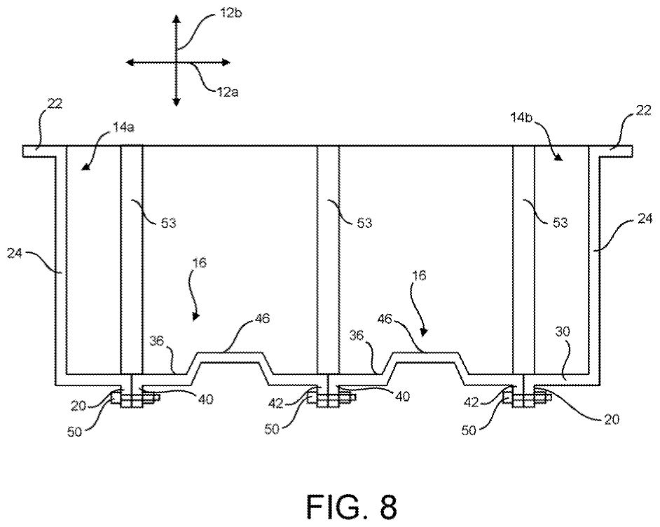

FIGS. 8 through 11 illustrate an example method by which a container may be made using a mold created using endcaps 14a, 14b and zero or more inner mold sections 16 and zero or more mold sections 18.

Referring specifically to FIG. 8, in the illustrated embodiment, end caps 14a, 14b are positioned with two inner mold sections 16 as shown. In the illustrated embodiments, the flanges of adjacent mold sections are secured to one another by bolts 50 and nuts 52. The number of bolts 50 and nuts 52 for each pair of adjacent flanges 20, 40, pair of adjacent flanges 42, 40, or pair of flanges 42, 20 may be according to a desired degree of clamping, such as separated by a maximum separation such as between 5 and 20 centimeters a pair of adjacent flanges 20, 40 or pair of flanges 42, 40.

In order to improve the quality of the final product, seams between adjacent mold sections 14a, 14b, 16, 18, 38a, 38b may include smoothing and/or sealing elements 53 such as tape, a liquid sealant (e.g., liquid polymer that subsequently hardens to form a flexible polymer), or some other material that smooths a gap or other discontinuity between adjacent mold sections 14a, 14b, 16, 18, 38a, 38b.

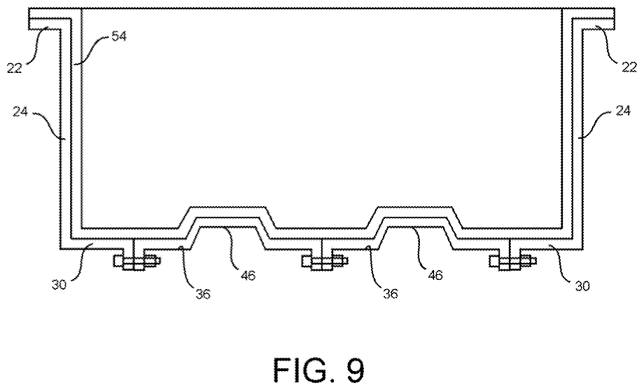

Referring to FIG. 9, material 54 may be placed on the inner surfaces of the mold sections 14a, 14b, 16. As is apparent in FIG. 9, the material may extend over the flanges 22, 44 of the mold sections 14a, 14b, 16. The material used may include a polymer, composite (carbon fiber and resin, fiberglass and resin), or any other material known in the art for fabrication of containers.

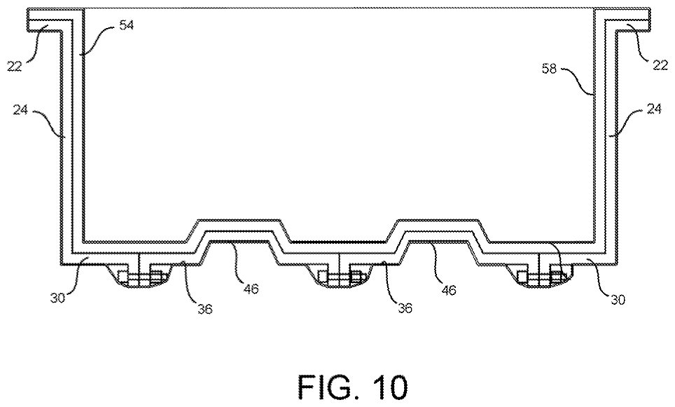

Referring to FIG. 10, where the material 56 is a composite such as carbon fiber, the material may be placed in a vacuum bag 58 from which air is at least partially evacuated in order to compress layers of carbon fiber and composite forming the material 54. Following this step, the material 54 and vacuum bag 58 may be processed, such as in an autoclave or other source of heat in order to cure the resin in the material 54. The manner in which the material 54 is cured may be according to any approach known in the art for manufacturing composites, such as carbon fiber, fiberglass, or other types of composite materials.

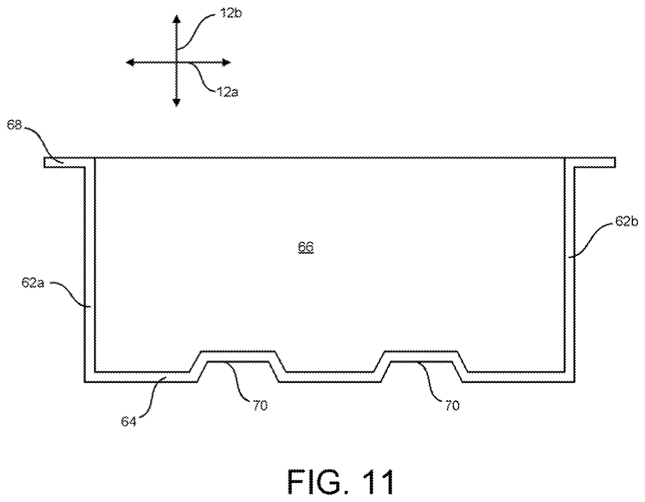

Referring to FIG. 11, following curing, a container part 68 formed from the material 56 may be removed from the mold as shown. The container part 68 may be removed from the vacuum bag 58 and from the mold sections 14a, 14b, 16. Additional processing may occur, such as trimming the flanges around the perimeter of the container part 68.

As is apparent, the container part 68 includes left and right walls 62a, 62b, a bottom wall 64, and a rear wall 66. Also present is a front wall (not shown) corresponding to the size and shape of the rear wall 66 but on an opposite side. The left and right walls 62a, 62b secure to opposite sides of the bottom wall 64 and may be perpendicular thereto and extend upwardly in the vertical direction 12b from the bottom wall. The rear wall secures to rear edges of the left and right walls 62a, 62b and to a rear edge of the bottom wall 64. The front wall secures to front edges of the left and right walls 62a, 62b. Features 70 corresponding to the features 46 of the inner mold sections 16 may also be present, which are indentations 70 extending upwardly into from the bottom wall 64 in the vertical direction 12b for receiving tines of a forklift in the illustrated embodiment.

As is apparent in FIG. 11, container part 68 may define an opening and define an interior volume accessible through the opening, the size of the opening and volume being dependent on the number of inner mold sections 16, 18 used in combination with the end caps 14a, 14b and the features being dependent on those of the inner mold sections 16 included in the mold. The illustrated approach design is therefore very versatile. Using a finite number of mold sections 16, 18, an enormous variety of container sizes may be implemented.

The container part 68 may be a container base. A container lid may be formed in the same manner, such as using end caps 14a, 14b and zero or more inner mold sections 16 and zero or more sections 18 that have a smaller height in the vertical direction 12b relative to those mold sections used to create the container base 68 but defining an identical opening in a plane parallel to the horizontal and longitudinal directions 12b, 12c as the container base 68 such that the container base and container lid may be fastened to one another (e.g., by hinges, clips, or other fasteners) to form a closable container.

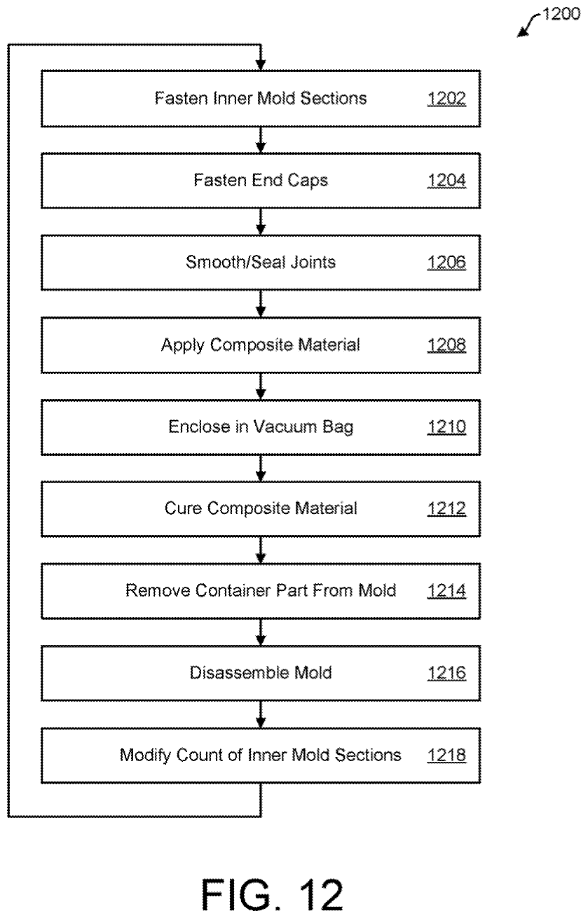

Referring to FIG. 12, a container according to the embodiments described hereinabove may be manufactured according to the illustrated method 1200. The method 1200 may include fastening 1202 a first number of inner mold sections to one another, such as any number of mold sections 16 and any number of mold sections 18 in any ordering or arrangement. As described above, fastening 1202 may include securing the right flange 42 of one inner mold section 16, 18 to the left flange 40 of another inner mold section 16, 18 using bolts, clips, or other fastening means.

The method 1200 may include fastening 1204 end caps 14a, 14b to the inner mold sections 16, 18 fastened at step 1202. As described above, this may include securing the flange 20 of the left end cap 14a to the right flange 42 of the leftmost inner mold section 16, 18 and securing the flange 20 of the right endcap 14b to the left flange 40 of the rightmost inner mold section 16, 18. Of course, steps 1202 and 1204 may be reversed such that end caps are fastened to one or more inner mold sections 16, 18 before any inner mold sections are fastened to one another.

In still other embodiments, step 1202 is omitted and end caps 14a, 14b are secured to one another by their flanges 20 by bolts.

The method 1200 may further include smoothing and/or sealing 1206 the joints between adjacent mold sections 14a, 14b, 16, 18 as fastened to one another at one or both of steps 1202, 1204. As noted above, this may include applying a smoothing or sealing material 53 such as tape, caulking, or other sealing or smoothing material.

The method 1200 may further include applying 1208 a composite material, such as pre-impregnated carbon fiber composite, fiberglass and resin, Kevlar composite and resin, or other fiber reinforced resin system. Step 1208 may include applying multiple layers of a composite material. In other embodiments, a non-fiber-reinforced resin (e.g., any thermoset plastic) or thermoplastic may be used in the place of a composite material (e.g., for rotomolding). The type of composite material and the manner in which it is applied 1208 may be according to any method known in the art.

Where the composite material is carbon fiber composite material, compression during curing may be desired. Accordingly, in such embodiments, the method 1200 may include enclosing the mold and composite material in a vacuum bag 1210 and evacuating gasses from the bag. The method 1200 may then include curing 1212 the composite material, such as by applying heat. Step 1212 may include heating the composite material and mold in an autoclave. In some embodiments, curing or hardening does not require heat such that only passage of time is required at step 1212, for example a chemical reaction, cooling, applying an ultraviolet light, or other hardening means may be used.

The method 1200 may then include removing 1214 the completed container part from the mold. The part as removed at step 1214 may be further processed such as by cutting off rough edges, sanding rough edges, securing handles, hinges, lids, and any other part of a container as known in the art.

The mold as assembled at one or both of steps 1202, 1204 may then be completely or partially disassembled 1216, such as by undoing bolts or other fastener securing any mold sections 14a, 14b, 16, 18 together. The count of inner mold sections may then be modified 1218, such as by introducing one or more additional mold sections 16, 18 or by removing one or more mold sections 16, 18 from the collection of mold sections 14a, 14b, 16, 18 that were fastened together at one or both of steps 1202, 1204. The method 1200 may then repeat at step 1202 with the modified collection of mold sections 14a, 14b, 16, 18. Note that in some instances, the same collection of mold sections is used but the ordering of inner mold sections 16, 18 may be changed in order to achieve a different size of mold.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method comprising:
making a first container using two end caps and a first portion of inner members by:
forming a first mold by securing the first portion of the inner members between the two end caps such that the two end caps and first portion of the inner members define a first opening and a first inner surface defining a first inner volume accessible by the first opening;
placing first material on the first inner surface; and
hardening the first material to form a first container portion; and
making a second container using a second portion of the inner members including at least some of the first portion of the inner members, the second portion being different in number of the inner members than the first portion, by:
forming a second mold by positioning the second portion of inner members between the two end caps such that the two end caps and second portion of the inner members define a second opening and a second inner surface defining a second inner volume accessible by the second opening, the second opening being different in size from the first opening and the second inner volume being different in size from the first inner volume;
placing second material on the second inner surface; and
hardening the second material to form a second container portion.

2. The method of claim 1, wherein the inner members are U-shaped members and the first opening is formed by upper edges of the two end caps and upper edges of the first portion of the inner members.

3. The method of claim 1, wherein one or more of the first portion of the inner members include projections extending into the first inner volume.

4. The method of claim 3, wherein the projections are sized to form indentations in the first container portion sized to receive lifting equipment.

5. A method comprising:
providing a left cap;
providing a right cap;
providing a plurality of inner members each with an inner wall having a front edge, a rear edge, a left edge extending between the front edge and the rear edge, and a right edge opposite the left edge, the inner wall defining an open channel extending from the left edge to the right edge;
(a) securing the left edge of a left inner member of the plurality of inner members to the left cap;
(b) securing the right edge of a right inner member of the plurality of inner members to the left cap;
(c) performing at least one of (i) securing the right edge of the left inner member to the left edge of the right inner member and (ii) for each inner member of a remaining portion of the plurality of inner members, the remaining portion excluding the left inner member and the right inner member and including, securing the left edge of each inner member to the right edge of another inner member of the plurality of inner members and securing the right edge of each inner member to the left edge of another inner member of the plurality of inner members such that the open channels of the plurality of inner members, the left cap, and the right cap define a mold having a female mold inner surface;
(d) applying material to the concave inner surface; and
(e) allowing the material to harden to form a first container member.

6. The method of claim 5, wherein the front edges and rear edges of the plurality of inner members are substantially aligned with one another and with top edges of the left cap and right cap.

7. The method of claim 6, further comprising inner top flanges secured to the front edges and rear edges of the plurality of inner members, a left top flange secured to the top edge of the left cap and a right top flange secured to the top edge of the right cap, the inner top flanges, left top flange, and right top flange being substantially aligned.

8. The method of claim 5, wherein the inner wall of each inner member of the plurality of inner members includes a bottom planar portion, a front planar portion secured on a first side of the bottom planar portion and being perpendicular to the bottom planar portion, and a rear planar portion secured on a second side of the bottom planar portion and being perpendicular to the bottom planar portion, the second side being opposite the first side.

9. The method of claim 8, wherein the left cap includes a left side wall, a left bottom wall secured to a bottom edge of the left side wall, a left front wall secured to a front edge of the left side wall, and a left rear wall secured to a rear edge of the left side wall, the method further comprising:
fastening the left bottom wall to the bottom planar portion of the left inner member;
fastening the left front wall to the front planar portion of the left inner member; and
fastening the left rear wall to the rear planar portion of the left inner member.

10. The method of claim 9, wherein the right cap includes a right side wall, a right bottom wall secured to a bottom edge of the right side wall, a right front wall secured to a front edge of the right side wall, and a right rear wall secured to a rear edge of the right side wall, the method further comprising:
fastening the right bottom wall to the bottom planar portion of the right inner member;
fastening the right front wall to the front planar portion of the right inner member; and
fastening the right rear wall to the rear planar portion of the right inner member.

11. The method of claim 10, wherein:
the left cap includes a left cap flange extending around the left front wall, left bottom wall, and left rear wall, the left cap flange being perpendicular to the left front wall, left bottom wall, and left rear wall;
the right cap includes a right cap flange extending around the right front wall, right bottom wall, and right rear wall, the right cap flange being perpendicular to the right front wall, right bottom wall, and right rear wall;
the plurality of inner members each include a left flange secured to the left edge of the inner wall and a right flange secured to the right edge of the inner wall;
securing the left edge of the left inner member of the plurality of inner members to the left cap comprises securing the left flange of the left inner member to the left cap flange;
securing the right edge of the right inner member of the plurality of inner members to the right cap comprises securing the right flange of the right inner member to the right cap flange;
securing the left edge of each inner member of the remaining portion to the right edge of another inner member of the plurality of inner members by securing the left flange of the each inner member to the right flange of another inner member of the plurality of inner members; and
securing the right edge of each inner member of the remaining portion to the left edge of another inner member of the plurality of inner members by securing the right flange of the each inner member to the left flange of another inner member of the plurality of inner members.

12. The method of claim 10, wherein at least two of the inner members positioned between the left cap and the right cap each include a projection extending upwardly from the bottom planar portion thereof and extending between the front planar portion and the rear planar portion.

13. The method of claim 12, wherein the projection is sized to form a cavity in the container member sized to receive a tine of a forklift.

14. The method of claim 5, further comprising removing at least one of the plurality of inner members from the mold and repeating (a) through (e) such that a number of inner members between the left cap and right cap in the mold is different than for a previous iteration of performing (a) through (e).

15. The method of claim 5, further comprising applying sealing material at junctions between the left cap and the left inner member, the right cap and the right inner member, and any other junctions between inner members in the mold.

16. The method of claim 5, wherein the material comprises carbon fiber and resin.

17. The method of claim 16, wherein allowing the material to harden comprises curing the resin.

18. The method of claim 17, wherein curing the material comprises applying a vacuum to the material and heating the material.

19. The method of claim 5, wherein the container member is a lid.

20. The method of claim 5, wherein the container member is a base of a container, the method further comprising manufacturing a lid according to (a), (b), (c), (d), and (e) and securing the lid to the base.
